(19) United States
(12) Patent Application Publication
(10) Pub. No.: US 2024/0302404 A1
(43) Pub. Date: Sep. 12, 2024

(54) ACCELERATION SENSOR

(71) Applicant: ROHM CO., LTD., Kyoto (JP)

(72) Inventor: Daisuke NISHINOHARA, Kyoto (JP)

(73) Assignee: ROHM CO., LTD., Kyoto (JP)

(21) Appl. No.: 18/591,627

(22) Filed: Feb. 29, 2024

(30) Foreign Application Priority Data
Mar. 7, 2023 (JP) 2023-034849

(51) Int. Cl. G01P 15/135; G01P 15/125; G01P 15/18

(52) U.S. Cl. CPC G01P 15/135; G01P 15/125; G01P 15/18

(57) ABSTRACT

The present disclosure provides an acceleration sensor. The acceleration sensor includes: a substrate; a first mass portion supported by the substrate so as to be movable along a thickness direction of the substrate; and a beam portion supporting the first mass portion on the substrate. The beam portion includes: a second mass portion having a mass less than a mass of the first mass portion; a first spring portion connecting the first mass portion with the second mass portion; and a second spring portion having a spring constant smaller than a spring constant of the first spring portion and connecting the second mass portion with the substrate. A movable electrode of a sensor element is disposed on the second mass portion and configured to detect an acceleration along the thickness direction of the substrate. A fixed electrode of the sensor element is disposed on the substrate.

### TECHNICAL FIELD

The present disclosure relates to an acceleration sensor

### BACKGROUND

Patent document 1 discloses a capacitive Micro Electro Mechanical System (MEMS) acceleration sensor. The acceleration sensor includes a first semiconductor substrate having an electrode formed on its surface, and a second semiconductor substrate bonded to the first semiconductor substrate and having a weight portion disposed opposite to the electrode. An acceleration along a thickness direction is detected by detecting a capacitance between the electrode and the weight portion that face each other along the thickness direction of the first and second semiconductor substrates.

### PRIOR ART DOCUMENT

### Patent Publication

[Patent document 1] Japan Patent Publication No. 8-285884A

### BRIEF DESCRIPTION OF THE DRAWINGS

FIG. 1 is a plan view of an acceleration sensor according to a first embodiment of the present disclosure.

FIG. 2 is a cross-sectional view of the acceleration sensor taken along line II-II in FIG. 1.

FIG. 3 is a cross-sectional view of the acceleration sensor taken along line III-III in FIG. 1.

FIG. 4 is an enlarged view of main portions of the acceleration sensor shown in FIG. 1.

FIG. 5 is a diagram showing a first mass portion and a beam portion at rest.

FIG. 6 is a diagram showing the first mass portion and the beam portion when acceleration is applied.

FIG. 7 is a cross-sectional view of the acceleration sensor taken along line VII-VII in FIG. 4.

FIG. 8 is a plan view of an acceleration sensor according to a second embodiment of the present disclosure.

FIG. 9 is a cross-sectional view of the acceleration sensor taken along line IX-IX in FIG. 8.

FIG. 10 is an enlarged view of main portions of the acceleration sensor shown in FIG. 8.

### DETAILED DESCRIPTION OF THE EMBODIMENTS

### Summary of Embodiments

Embodiments of the present disclosure are described below with reference to the accompanying drawings.

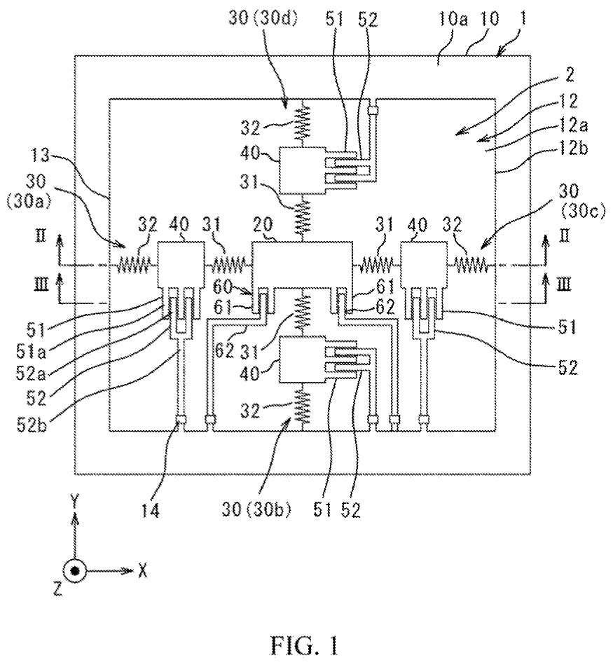

FIG. 1 is a plan view of an acceleration sensor according to a first embodiment of the present disclosure. As shown in FIG. 1, an acceleration sensor 1 according to the first embodiment is a capacitive MEMS acceleration sensor, which includes a substrate 10 having a sensor element 2. A semiconductor substrate such as a single crystal silicon substrate doped with impurities to impart conductivity is used as the substrate 10. The acceleration sensor 1 is manufactured by processing a substrate 10 using semiconductor microfabrication technology.

Although not shown, the substrate 10 is disposed with a plurality of pad portions. The pad portions are connected to an external electronic component or the like, and used to input electrical signals to the sensor element 2 or output electrical signals from the sensor element 2. Although not shown, the substrate 10 is disposed with wirings that electrically connect the pad portions to the sensor element 2.

Hereinafter, a predetermined direction along a surface of the substrate 10 is referred to as an X direction, a direction along the surface of the substrate 10 and perpendicular to the X direction is referred to as a Y direction, and a thickness direction of the substrate 10 perpendicular to the surface of the substrate 10 is referred to as a Z direction. FIG. 1 shows the substrate 10 viewed from one side along the Z direction.

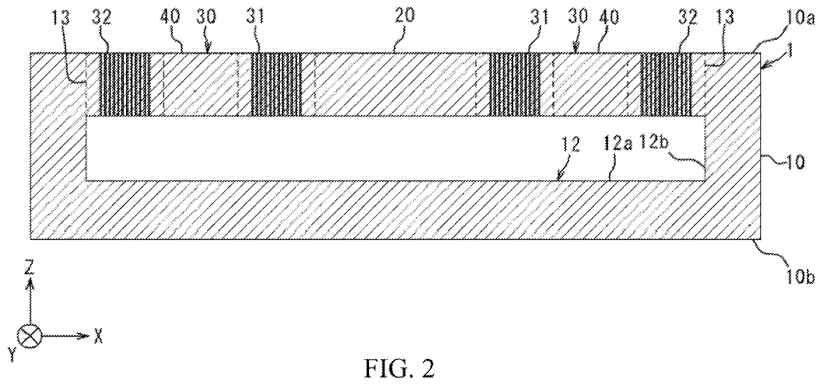

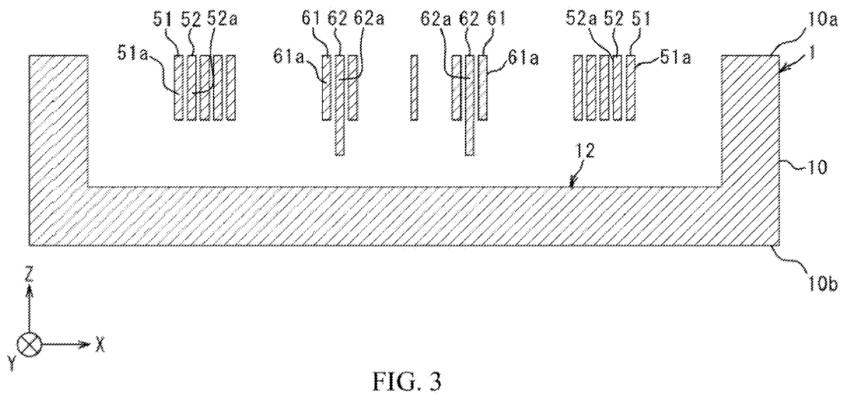

FIG. 2 is a cross-sectional view of the acceleration sensor taken along line II-II in FIG. 1. FIG. 3 is a cross-sectional view of the acceleration sensor taken along line III-III in FIG. 1. The acceleration sensor 1 includes the sensor element 2 on the substrate 10 that detects acceleration acting along the Z direction.

As shown in FIGS. 2 and 3, the substrate 10 has a first main surface 10a which is a front surface and a second main surface 10b which is a back surface opposite to the first main surface 10a. The substrate 10 has a predetermined thickness along the Z direction. The substrate 10 is formed into a rectangular shape with two sides extending along the X direction and two sides extending along the Y direction in a plan view.

As shown in FIG. 1, the substrate 10 has a cavity 12 on a center side that corresponds to the sensor element 2 and is partially exposed on the first main surface 10a. The cavity 12 is formed into a substantially rectangular parallelepiped shape from the first main surface 10a along the Z direction. The cavity 12 has a bottom wall portion 12a and a side wall portion 12b extending from the bottom wall portion 12a along the Z direction.

The acceleration sensor 1 includes a first mass portion 20 supported movably along the Z direction on the substrate 10, and a beam portion 30 that supports the first mass portion 20 on the substrate 10. The first mass portion 20 and the beam portion 30 are formed by parts of the substrate 10. The substrate 10 is disposed with a support portion 13 that supports the first mass portion 20 and the beam portion 30.

The support portion 13 is formed into a substantially square annular shape in the plan view so as to surround a periphery of the sensor element 2. An inner circumferential surface of the support portion 13 is formed by the side wall portion 12b of the cavity 12. The first mass portion 20 and the beam portion 30 are disposed within the cavity 12 and supported by the support portion 13 while floating within the cavity 12.

The first mass portion 20 has a mass m1 and is formed into a substantially rectangular shape with two sides extending along the X direction and two sides extending along the Y direction in the plan view. The first mass portion 20 has substantially the same cross section along the Z direction and has a predetermined thickness along the Z direction. The first mass portion 20 is supported by the support portion 13 by four beam portions 30. The four beam portions 30 are arranged evenly around the first mass portion 20 in the plan view, and are arranged at intervals of 90 degrees around the first mass portion 20.

A beam portion 30a is arranged on the other side of the first mass portion 20 along the X direction, a beam portion 30b is arranged on the other side of the first mass portion 20 along the Y direction, a beam portion 30c is arranged on one side of the first mass portion 20 along the X direction and a beam portion 30d is arranged on one side of the first mass portion 20 along the Y direction. The two beam portions 30a and 30c are formed symmetrically with the first mass portion 20 disposed in between, and the two beam portions 30b and 30d are formed symmetrically with the first mass portion 20 disposed in between. The four beam portions 30 are rotated 90 degrees in the plan view and are configured in substantially the same way.

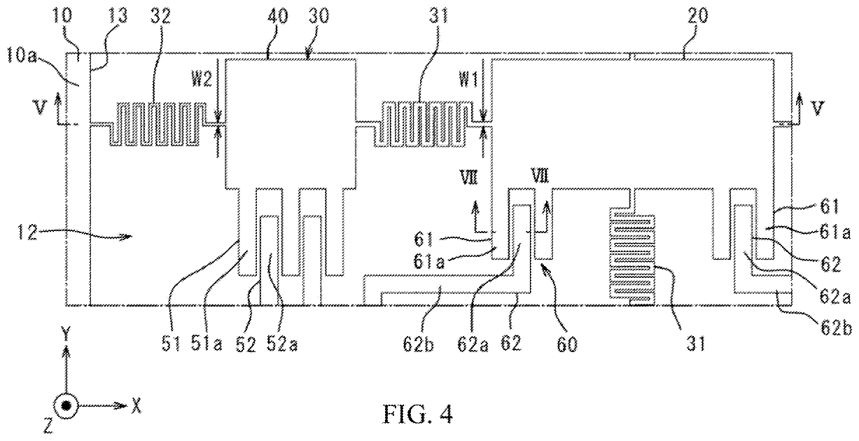

FIG. 4 is an enlarged view of main portions of the acceleration sensor shown in FIG. 1. As shown in FIG. 4, the beam portion 30 includes a second mass portion 40, a first spring portion 31 that connects the first mass portion 20 and the second mass portion 40, and a second spring portion 32 that connects the second mass portion 40 and the substrate 10. The first spring portion 31, the second mass portion 40 and the second spring portion 32 are arranged to extend linearly from the first mass portion 20.

The second mass portion 40 has a mass m2 and is formed into a substantially rectangular shape with two sides extending along the X direction and two sides extending along the Y direction in the plan view. The second mass portion 40 has substantially the same cross section along the Z direction and has the same predetermined thickness as the first mass portion 20 along the Z direction. The second mass portion 40 has a mass less than that of the first mass portion 20, and specifically, the second mass portion 40 is formed to have a mass sufficiently less than that of the first mass portion 20. The second mass portion 40 is formed to have a less area in the plan view than the first mass portion 20 and has a less mass than the first mass portion 20. A ratio (m2/m1) of the mass m2 of the second mass portion 40 to the mass m of the first mass portion 20 is set to, for example, 1/10.

The first spring portion 31 has a spring constant k1, and is configured to be expandable and contractible along a direction in which the beam portion 30 linearly extends from the first mass portion 20. The first spring portion 31 is formed into a linear shape having a predetermined width W1 in the plan view. The first spring portion 31 is formed by being folded back multiple times (12 times in FIG. 4) along a direction perpendicular to the direction in which the beam portion 30 linearly extends. The first spring portion 31 has substantially the same cross section along the Z direction, and has the same predetermined thickness as the first mass portion 20 along the Z direction.

The second spring portion 32 has a spring constant k2, and is configured to be expandable and contractible along the direction in which the beam portion 30 linearly extends from the first mass portion 20. The second spring portion 32 is formed into a linear shape having a predetermined width W2 in the plan view. The second spring portion 32 is formed by being folded back multiple times (12 times in FIG. 4) along a direction perpendicular to the direction in which the beam portion 30 linearly extends. The second spring portion 32 has substantially the same cross section along the Z direction, and has the same predetermined thickness as the second mass portion 40 along the Z direction.

The second spring portion 32 has a spring constant smaller than that of the first spring portion 31, and specifically, the second spring portion 32 is formed to have a spring constant sufficiently smaller than that of the first spring portion 31. The second spring portion 32 has a predetermined width W2 less than the predetermined width W1 of the first spring portion 31 in the plan view, and has a spring constant smaller than that of the First spring portion 31. A ratio (k2/k1) of the spring constant k2 of the second spring portion 32 to the spring constant k1 of the first spring portion 31 is set to, for example, 1/10.

The beam portion 30 supports the first mass portion 20 on the support portion 13 of the substrate 10 via the first spring portion 31, the second mass portion 40 and the second spring portion 32. In the beam portion 30, the second mass portion 40 is formed to have a mass less than that of the first mass portion 20, and the second spring portion 32 is formed to have a spring constant smaller than that of the first spring portion 31.

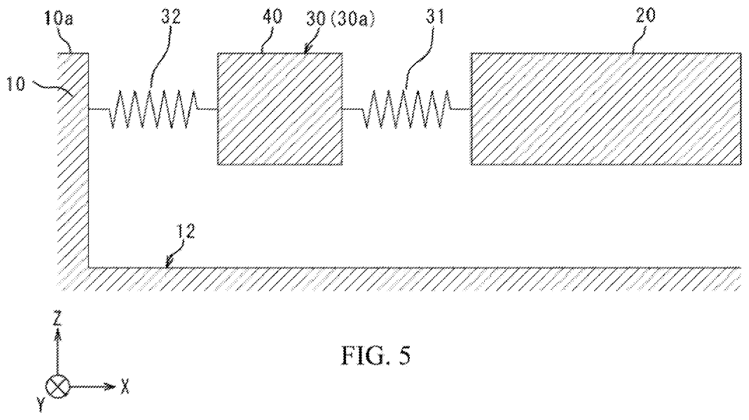

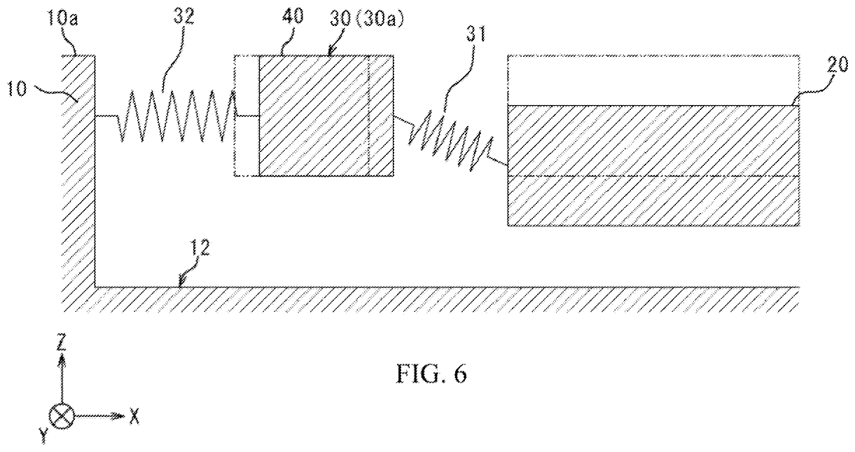

FIG. 5 is a diagram showing the first mass portion and the beam portion at rest. FIG. 6 is a diagram showing the first mass portion and the beam portion when acceleration is applied. FIGS. 5 and 6 show a cross-sectional view of the acceleration sensor 1 taken along the line V-V in FIG. 4. As shown in FIG. 5, when the acceleration sensor 1 is at rest and no acceleration is applied, the first mass portion 20 and the second mass portion 40 have surfaces on one side along the Z direction that are aligned with the first main surface 10a of the substrate 10 along the Z direction. They are arranged such that their directional positions are the same.

As shown in FIG. 6, when an acceleration is applied to the acceleration sensor 1 along the Z direction, the first mass portion 20 supported movably along the Z direction by the beam portion 30 is displaced relative to the substrate 10 along the Z direction in response to the acceleration. In FIG. 6, the first mass portion 20 is displaced along the Z direction from the first mass portion 20 when it is at rest, indicated by a two-dot chain line, to the first mass portion 20 when it is being accelerated, indicated by a solid line.

In the beam portion 30, the second mass portion 40 has a mass less than that of the first mass portion 20, and the second spring portion 32 has a spring constant smaller than that of the first spring portion 31. The second mass portion 40 is displaced in a direction that approaches the first mass portion 20 along a direction perpendicular to the Z direction. In the beam portion 30a, the second mass portion 40 is displaced to one side along the X direction. In the beam portion 30b, the second mass portion 40 is displaced to one side along the Y direction. In the beam portion 30c, the second mass portion 40 is displaced to the other side along the X direction. In the beam portion 30d, the second mass portion 40 is displaced to the other side along the Y direction.

Although FIG. 6 shows a case when the acceleration toward one side along the Z direction acts on the acceleration sensor 1, also when the acceleration toward the other side along the Z direction acts on the acceleration sensor 1, the first mass portion 20 is displaced relative to the substrate 10 along the Z direction, and the second mass portion 40 is displaced in a direction that approaches the first mass portion 20 in a direction perpendicular to the Z direction in response to the acceleration.

As shown in FIG. 4, the acceleration sensor 1 includes a movable electrode 51 for acceleration detection of the sensor element 2 for detecting acceleration along the Z direction, and a fixed electrode 52 for acceleration detection of the sensor element 2 for detecting acceleration along the thickness direction of the substrate 10. The movable electrode 51 is fixed to the second mass portion 40, and the fixed electrode 52 is fixed to the support portion 13 of the substrate 10. The movable electrode 51 is movable relative to the fixed electrode 52 along a direction perpendicular to the Z direction.

The movable electrode 51 includes a movable electrode portion 51a. The movable electrode portion 51a extends linearly along a direction perpendicular to the direction in which the beam portion 30 linearly extends from the first mass portion 20 in the plan view. The movable electrode portion 51a is formed in a shape of comb-teeth that are spaced apart at equal intervals along the direction in which the beam portion 30 linearly extends. The movable electrode portion 51a has the same cross section along the Z direction and a predetermined thickness along the Z direction.

The fixed electrode 52 includes a fixed electrode portion 52a and a base portion 52b connected to the fixed electrode portion 52a and the support portion 13 of the substrate 10. The fixed electrode portion 52a extends linearly along a direction perpendicular to the direction in which the beam portion 30 extends linearly from the first mass portion 20 in the plan view. The fixed electrode portion 52a is disposed in a shape of comb-teeth facing and meshing with the movable electrode portion 51a without contacting each other. The fixed electrode portion 52a has the same cross section along the Z direction and has a predetermined thickness along the Z direction.

As shown in FIG. 1, movable electrodes 51 and fixed electrodes 52 of the sensor element 2 are arranged in correspondence with the four beam portions 30, respectively. The movable electrodes 51 and fixed electrodes 52 provided on the four beam portions 30 are configured in substantially the same way. An isolation portion 14 is disposed in the base portion 52b of the fixed electrode 52 for electrically isolating the fixed electrode 52 and the support portion 13 of the substrate 10 and mechanically connecting the same. The isolation portion 14 is made of silicon oxide or the like.

As described above, when an acceleration along the Z direction acts on the acceleration sensor 1, the first mass portion 20 is relatively displaced to the substrate 10 along the Z direction, and the second mass portion 40 is displaced in a direction that approaches the first mass portion 20 along a direction perpendicular to the Z direction in response to the acceleration. According to the above, a capacitance between the movable electrode 51 and the fixed electrode 52 may change. The sensor element 2 detects a change in capacitance between the movable electrode 51 and the fixed electrode 52 and extracts it as an electrical signal, thereby detecting the acceleration along the Z direction; specifically, a magnitude of the acceleration along the Z direction is detected.

The acceleration sensor 1 includes a direction detection mechanism 60 for detecting an acceleration direction along the Z direction. The direction detection mechanism 60 includes a movable electrode 61 for direction detection and a fixed electrode 62 for direction detection that detects the acceleration direction along the Z direction.

The movable electrode 61 is fixed to the first mass portion 20, and the fixed electrode 62 is fixed to the support portion 13 of the substrate 10. The movable electrode 61 is movable along the Z direction relative to the fixed electrode 62. In the acceleration sensor 1, on the other side of the first mass portion 20 along the Y direction, movable electrodes 61 are disposed on both sides of the first mass portion 20 along the X direction, and fixed electrodes 62 are disposed in correspondence with the movable electrodes 61, respectively.

The movable electrode 61 includes a movable electrode portion 61a, as shown in FIG. 4. The movable electrode portion 61a extends linearly from the first mass portion 20 along the Y direction in the plan view. The movable electrode 61 has the same cross section along the Z direction and has a predetermined thickness along the Z direction.

The fixed electrode 62 includes a fixed electrode portion 62a and a base portion 62b connected to the fixed electrode portion 62a and the support portion 13 of the substrate 10. The fixed electrode portion 62a extends linearly along the Y direction in the plan view. The fixed electrode portion 62a and the movable electrode portion 61a are disposed to face and mesh with each other without contacting each other. The fixed electrode 62 has the same cross section along the Z direction and has a predetermined thickness along the Z direction.

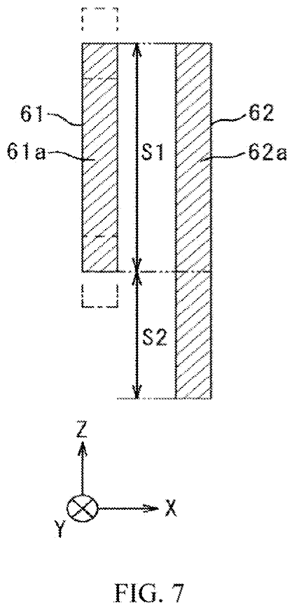

FIG. 7 is a cross-sectional view of the acceleration sensor taken along line VII-VII in FIG. 4. As shown in FIG. 7, the fixed electrode 62 is formed thicker along the Z direction than the movable electrode 61, and is formed longer than the movable electrode 61 on the other side along the Z direction. The movable electrode 61 and the fixed electrode 62 have an overlap region S1 where positions along the Z direction overlap, and a non-overlap region S2 where positions along the Z direction do not overlap. Note that the movable electrode 61 may be formed longer than the fixed electrode 62 on the other side along the Z direction, and the movable electrode 61 and the fixed electrode 62 may have an overlap region S1 and a non-overlap region S2.

When an acceleration toward one side along the Z direction acts on the acceleration sensor 1, the first mass portion 20 is displaced to the other side along the Z direction with respect to the substrate 10, and the movable electrode 61 is displaced to the other side along the Z direction with respect to the fixed electrode 62, as shown by the dashed line in FIG. 7. As a result, the overlap region S1 of the movable electrode 61 and the fixed electrode 62 is maintained, and a capacitance between the movable electrode 61 and the fixed electrode 62 is maintained.

On the other hand, when an acceleration toward the other side along the Z direction acts on the acceleration sensor 1, the first mass portion 20 is displaced toward the one side along the Z direction with respect to the substrate 10, and the movable electrode 61 is displaced to the one side along the Z direction with respect to the fixed electrode 62, as shown by the broken line in FIG. 7. As a result, the overlap region S1 of the movable electrode 61 and the fixed electrode 62 is reduced, and the capacitance between the movable electrode 61 and the fixed electrode 62 is reduced. The direction detection mechanism 60 detects the acceleration direction along the Z direction by detecting a change in capacitance between the movable electrode 61 and the fixed electrode 62 and extracting it as an electric signal.

Next, a method for manufacturing the acceleration sensor 1 will be described. In manufacturing the acceleration sensor 1, a substrate 10 is provided. A trench is formed in the substrate 10 by removing a portion corresponding to an isolation portion 14. After the trench is formed, the trench is thermally oxidized by a thermal oxide film to form the isolation portion 14.

Next, a silicon oxide film is formed as an insulating film on the isolation portion 14 and a first main surface 10a of the substrate 10 by a CVD method. The silicon oxide film is patterned by photolithography and etching so as to leave a portion corresponding to a wiring and to form a contact hole. Then, the contact hole is filled with metal such as tungsten to form a contact, and after the contact is formed, a wiring and a pad portion are formed.

Next, a silicon oxide film is formed on the substrate 10 by a CVD method, and the substrate 10 is patterned by photolithography and anisotropic etching. As shown in FIG. 4, a trench is formed so as to leave a first mass portion 20, a beam portion 30, movable electrodes 51, 61, and fixed electrodes 52, 62. Thereafter, the trench is deeply formed by isotropic etching, and the trench is etched in a direction parallel to the first main surface 10a of the substrate 10 to form a cavity 12 that is partially exposed on the first main surface 10a. At the same time, the first mass portion 20, the beam portion 30, the movable electrodes 51, 61, and the fixed electrodes 52, 62 are arranged in a floating state within the cavity 12.

In such way, the first mass portion 20 supported movably along a thickness direction of the substrate 10 and the beam portion 30 that supports the first mass portion 20 on the substrate 10 are disposed on the substrate 10. The beam portion 30 includes a second mass portion 40, a first spring portion 31 and a second spring portions 32. The movable electrode 61 of a direction detection mechanism 60 is disposed on the first mass portion 20. The fixed electrode 62 of the direction detection mechanism 60 is disposed on the substrate 10. The movable electrode 51 of a sensor element 2 is disposed on the second mass portion 40. The fixed electrode 52 of the sensor element 2 is disposed on the substrate 10.

Although the acceleration sensor 1 may include one beam portion 30, it is preferable to include a plurality of beam portions 30. It is preferable that the plurality of beam portions 30 are arranged evenly around the first mass portion 20 in a plan view. The acceleration sensor 1 may include only two beam portions 30a and 30b, or may include only two beam portions 30b and 30d.

Although the second mass portion 40 has a surface area less than that of the first mass portion 20 in the plan view, and has a mass less than that of the first mass portion 20, the mass may be made to be less than that of the first mass portion 20 by other methods. Although the second spring portion 32 has a width less than that of the first spring portion 31 in the plan view, and has a spring constant smaller than that of the first spring portion 31, the spring constant may be made to be smaller than that of the first spring portion 31 by other methods.

In this way, the acceleration sensor 1 according to the present embodiment includes: the first mass portion 20 supported movably along the thickness direction of the substrate 10; and the beam portion 30 that supports the first mass portion 20 on the substrate 10. The beam portion 30 includes: the second mass portion 40 having a mass less than a mass of the first mass portion 20; the first spring portion 31 that connects the first mass portion 20 with the second mass portion 40; and the second spring portion 32 that has a spring constant smaller than a spring constant of the first spring portion 31 and connects the second mass portion 40 with the substrate 10. In addition, the movable electrode 51 of the sensor element 2 is disposed on the second mass portion 40 for detecting an acceleration along the thickness direction of the substrate 10, and the fixed electrode 52 of the sensor element 2 is disposed on the substrate 10.

As a result, when the acceleration along the thickness direction of the substrate 10 acts on the acceleration sensor 1, the first mass portion 20 is displaced along the thickness direction of the substrate 10 with respect to the substrate 10. As the first mass portion 20 is displaced, since the second mass portion 40 has a mass smaller than that of the first mass portion 20 and the second spring portion 32 has a spring constant smaller than that of the first spring portion 31, the second mass portion 40 is displaced in a direction that approaches the first mass portion 20 along a direction perpendicular to the thickness direction of the substrate 10. The movable electrode 51 and the fixed electrode 52 formed on the second mass portion 40 and the substrate 10, respectively, are arranged to face each other along the direction perpendicular to the thickness direction of the substrate 10. The acceleration along the thickness direction of the substrate 10 can be detected by detecting a capacitance between the movable electrode 51 and the fixed electrode 52 displaced along the direction perpendicular to the thickness direction of the substrate 10. Compared with a case when a capacitance between a movable electrode and a fixed electrode displaced along the thickness direction of the substrate is detected, the sensitivity of the sensor can be improved.

An acceleration sensor that detects an acceleration along a thickness direction of a substrate by detecting a change in capacitance between a movable electrode and a fixed electrode displaced along the thickness direction of the substrate is a variable inter-electrode area type acceleration sensor, in which an overlap area between electrodes changes in accordance with the acceleration. In such case, a capacitance sensitivity, which is proportional to a ratio of capacitance change amount to displacement amount, can be expressed as ε·S/d (ε: dielectric constant, S: area between electrodes, d: distance between electrodes). Although it is possible to increase the sensitivity by increasing the area between electrodes or decreasing the distance between electrodes, it is not possible to improve the signal-to-noise ratio (S/N ratio), which is proportional to the ratio of the capacitance sensitivity to an amount of capacitance change because the capacitance itself increases in proportion to the increase in the capacitance sensitivity.

The acceleration sensor 1 that detects the acceleration along the thickness direction of the substrate 10 by detecting a change in capacitance between the movable electrode 51 and the fixed electrode 52 displaced in a direction perpendicular to the thickness direction of the substrate 10 is a variable inter-electrode distance type acceleration sensor 1, in which the distance between electrodes 51 and 52 is varied in accordance with the acceleration. In such case, the capacitance sensitivity, which is proportional to the ratio of capacitance change amount to displacement amount, can be expressed as ε·S/d² (ε: dielectric constant, S: area between electrodes, d: distance between electrodes). By reducing the distance between the electrodes, it is possible to increase the sensitivity in inverse proportion to the square of the distance between the electrodes, and the capacitance sensitivity can be increased more than increasing the capacitance itself. It is possible to improve the S/N ratio, which is proportional to the ratio of the capacitance sensitivity to the amount of capacitance change.

Furthermore, the movable electrode 51 includes a movable electrode portion 51a formed in a comb-teeth shape, and the fixed electrode 52 includes a fixed electrode portion 52a formed in a comb-teeth shape. Therefore, the acceleration along the thickness direction of the substrate 10 can be detected by detecting the capacitance between the movable electrode portion 51a and the fixed electrode portion 52a which are formed in the comb-teeth shape.

Furthermore, the movable electrode portion 51a and the fixed electrode portion 52a are arranged to face each other along the direction perpendicular to the thickness direction of the substrate 10. Therefore, by detecting the capacitance between the comb-shaped movable electrode portion 51a and the fixed electrode portion 52a arranged to face each other along the direction perpendicular to the thickness direction of the substrate 10, the acceleration can be detected.

Furthermore, the substrate 10 has the cavity 12 that is partially exposed on the surface 10a. The first mass portion 20 and the beam portion 30 are provided on the substrate 10 so as to be disposed within the cavity 12. Therefore, the first mass portion 20 and the beam portion 30 can be arranged in a floating state within the cavity 12 of the substrate 10, and the acceleration sensor 1 can be configured compactly.

Furthermore, the acceleration sensor 1 includes a plurality of beam portions 30, and the plurality of beam portions 30 are evenly arranged around the first mass portion 20 in the plan view. Therefore, compared to a case when the first mass portion 20 is supported by one beam portion, the first mass portion 20 can be stably supported and the acceleration can be detected with high accuracy.

Furthermore, the acceleration sensor 1 may include two beam portions 30, and the two beam portions 30 may be formed symmetrically with the first mass portion 20 disposed in between. Therefore, the first mass portion 20 can be stably supported using the two beam portions 30 formed symmetrically with the first mass portion 20 disposed in between, and the acceleration can be detected with high accuracy.

Furthermore, the acceleration sensor 1 includes four beam portions 30. Therefore, the first mass portion 20 can be stably supported using the four beam portions 30 evenly arranged around the first mass portion 20, and the acceleration can be detected with high accuracy.

Furthermore, the direction detection mechanism 60 for detecting an acceleration direction along the thickness direction of the substrate 10 is provided. Therefore, when the acceleration along the thickness direction of the substrate 10 acts on the acceleration sensor 1, it is possible to detect whether the acceleration is toward one side along the thickness direction of the substrate 10 or toward the other side along the thickness direction of the substrate 10 using the direction detection mechanism 60.

Furthermore, the movable electrode 51 is a movable electrode for acceleration detection 51, and the fixed electrode 52 is a fixed electrode for acceleration detection 52. The direction detection mechanism 60 includes a movable electrode 61 for direction detection and a fixed electrode 62 for direction detection that detects the acceleration direction along the thickness direction of the substrate 10. The movable electrode 61 is disposed on the first mass portion 20 for direction detection, and the fixed electrode 62 is disposed on the substrate 10 for direction detection. Therefore, by detecting a change in capacitance between the movable electrode 61 for direction detection disposed on the first mass portion 20 and the fixed electrode 62 for direction detection disposed on the substrate 10, the acceleration direction along the thickness direction of the substrate 10 can be detected.

Furthermore, the movable electrode 61 for direction detection and the fixed electrode 62 for direction detection have an overlap region S1 where positions along the thickness direction of the substrate 10 overlap, and a non-overlap region S2 where positions along the thickness direction of the substrate 10 do not overlap. Therefore, in cases when the acceleration acts on one side along the thickness direction of the substrate 10 and when the acceleration acts on the other side along the thickness direction of the substrate 10, the capacitance between the movable electrode 61 for direction detection and the fixed electrode 62 for direction detection may change, and thus the acceleration direction along the thickness direction of the substrate 10 can be detected.

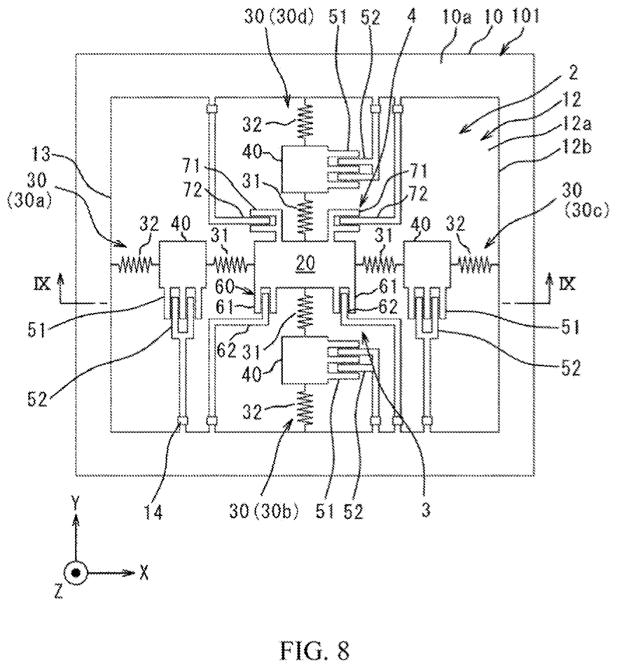

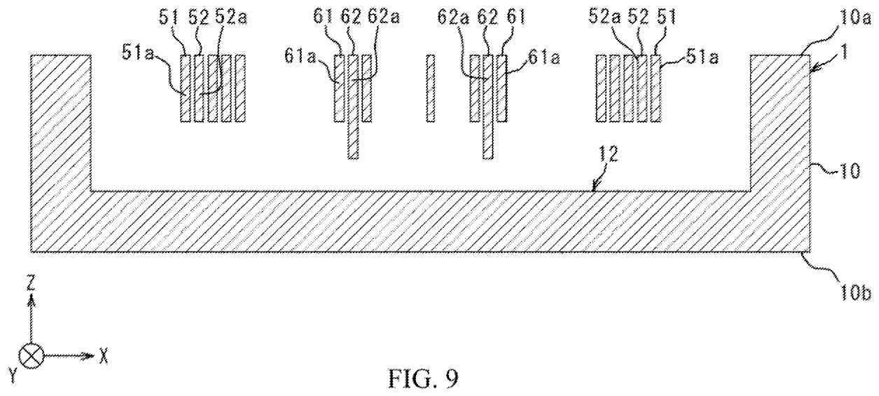

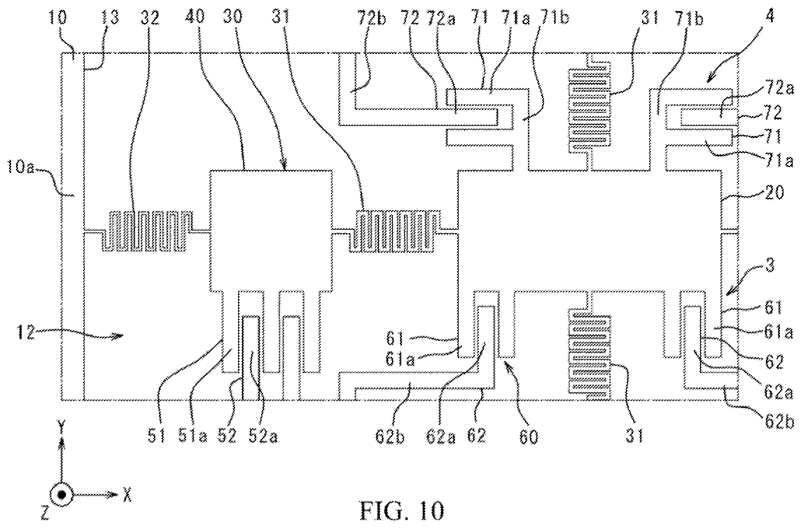

FIG. 8 is a plan view of an acceleration sensor according to a second embodiment of the present disclosure. FIG. 9 is a cross-sectional view of the acceleration sensor taken along line IX-X in FIG. 8. FIG. 10 is an enlarged view of main portions of the acceleration sensor shown in FIG. 8. An acceleration sensor 101 according to the second embodiment is the acceleration sensor 1 according to the first embodiment equipped with a sensor element for detecting an acceleration along the X direction and a sensor element for detecting an acceleration along the Y direction. Description of similar configurations will be omitted.

The acceleration sensor 101 according to the second embodiment, which is similar to the acceleration sensor 1, includes a first mass portion 20 supported movably along the Z direction, and a beam portion 30 that supports the first mass portion 20 on the substrate 10, as shown in FIG. 8. The beam portion 30 includes: a second mass portion 40 having a mass less than a mass of the first mass portion 20; a first spring portion 31 that connects the first mass portion 20 with the second mass portion 40; and a second spring portion 32 that has a spring constant smaller than a spring constant of the first spring portion 31 and connects the second mass portion 40 with the substrate 10. In addition, a movable electrode 51 of a sensor element 2 is disposed on the second mass portion 40 for detecting an acceleration along the Z direction, and a fixed electrode 52 of the sensor element 2 is disposed on the substrate 10.

The acceleration sensor 101 includes a direction detection mechanism 60 for detecting an acceleration direction along the Z direction. The direction detection mechanism 60 includes a movable electrode 61 for direction detection disposed on the first mass portion 20 and a fixed electrode 62 for direction detection disposed on a support portion 13 of the substrate 10. The movable electrode 61 and the fixed electrode 62 have an overlap region S1 and a non-overlap region S2. By detecting a change in capacitance between the movable electrode 61 and the fixed electrode 62, the acceleration direction along the Z direction can be detected.

Movable electrodes 61 for direction detection are disposed on both sides of the first mass portion 20 along the X direction. Fixed electrodes 62 for direction detection are fixed to the substrate 10 in correspondence with the movable electrodes 61 for direction detection, respectively. Each of the movable electrodes 61 includes a movable electrode portion 61a formed in a comb-teeth shape. Each of the fixed electrodes 62 includes a fixed electrode portion 62a and a base portion 62b.

The acceleration sensor 101 includes a sensor element 2 for detecting an acceleration along the Z direction, a sensor element 3 for detecting an acceleration along the X direction perpendicular to the Z direction and a sensor element 4 for detecting an acceleration along the Y direction perpendicular to the X direction and perpendicular to the Z direction.

The acceleration sensor 101 includes a movable electrode 61 for acceleration detection of the sensor element 3 for detecting the acceleration along the X direction and a fixed electrode 62 for acceleration detection of the sensor element 3 for detecting the acceleration along the X direction. In such embodiment, the movable electrode 61 for acceleration detection of the sensor element 3 is configured by the movable electrode 61 for direction detection, and the fixed electrode 62 for acceleration detection of the sensor element 3 is configured by the fixed electrode 62 for direction detection.

Movable electrodes 61 for acceleration detection are disposed on the other side of the first mass portion 20 along the Y direction and on both sides of the first mass portion 20 along the X direction. Fixed electrodes 62 for acceleration detection are fixed to the substrate 10 on the other side of the first mass portion 20 along the Y direction in correspondence with the movable electrodes 61 for acceleration detection disposed on both sides of the first mass portion 20 along the X direction.

As shown in FIG. 10, the movable electrode 61 includes a plurality of movable electrode portions 61a. The plurality of movable electrode portions 61a are formed in a comb-teeth shape, extending linearly along the Y direction and spaced apart along the X direction in the plan view. The movable electrode 61 has the same cross section along the Z direction and has a predetermined thickness along the Z direction.

The fixed electrode 62 includes the fixed electrode portion 62a and the base portion 62b connected to the fixed electrode portion 62a and the support portion 13 of the substrate 10. The fixed electrode portion 62a extends linearly along the Y direction in the plan view. The fixed electrode portion 62a is arranged to mesh with the movable electrode portion 61a without contacting each other. The movable electrode portion 61a and the fixed electrode portion 62a are arranged to face each other with an interval along the X direction. The fixed electrode 62 has the same cross section along the Z direction and has a predetermined thickness along the Z direction.

When an acceleration along the X direction acts on the acceleration sensor 101, the movable electrode portion 61a of the movable electrode 61 moves along the X direction relative to the fixed electrode portion 62a of the fixed electrode 62 in accordance with the acceleration. A capacitance between the fixed electrode 62 and the movable electrode 61 may change. The sensor element 3 is capable of detecting the acceleration along the X direction by detecting a change in capacitance between the movable electrode 61 and the fixed electrode 62 and extracting it as an electrical signal.

The acceleration sensor 101 includes a movable electrode 71 for acceleration detection of the sensor element 4 for detecting the acceleration along the Y direction and a fixed electrode 72 for acceleration detection of the sensor element 4 for detecting the acceleration along the Y direction.

Movable electrodes 71 for acceleration detection are disposed on one side of the first mass portion 20 along the Y direction and on both sides of the first mass portion 20 along the X direction. Fixed electrodes 72 for acceleration detection are fixed to the substrate 10 on one side of the first mass portion 20 along the Y direction in correspondence with the movable electrodes 71 for acceleration detection disposed on both sides of the first mass portion 20 along the X direction.

As shown in FIG. 10, the movable electrode 71 includes a plurality of movable electrode portions 71a and a base portion 71b connected to the plurality of movable electrode portions 71a and to the first mass portion 20. The plurality of movable electrode portions 71a are formed in a comb-teeth shape, extending linearly along the X direction and spaced apart along the Y direction in the plan view. The movable electrode 71 has the same cross section along the Z direction and has a predetermined thickness along the Z direction.

The fixed electrode 72 includes a fixed electrode portion 72a and a base portion 72b connected to the fixed electrode portion 72a and the support portion 13 of the substrate 10. The fixed electrode portion 72a extends linearly along the X direction in the plan view. The fixed electrode portion 72a is arranged to mesh with the movable electrode portion 71a without contacting each other. The movable electrode portion 71a and the fixed electrode portion 72a are arranged to face each other with an interval along the Y direction. The fixed electrode 72 has the same cross section along the Z direction and has a predetermined thickness along the Z direction. The fixed electrode 72 and the movable electrode 71 have the same thickness along the Z direction, and only have an overlap region S1 where positions along the Z direction overlap.

When an acceleration along the Y direction acts on the acceleration sensor 101, the movable electrode portion 71a of the movable electrode 71 moves along the Y direction relative to the fixed electrode portion 72a of the fixed electrode 72 in accordance with the acceleration. A capacitance between the fixed electrode 72 and the movable electrode 71 may change. The sensor element 4 is capable of detecting the acceleration along the Y direction by detecting a change in capacitance between the fixed electrode 72 and the movable electrode 71 and extracting it as an electrical signal.

In the acceleration sensor 101, the movable electrode 71 for acceleration detection and the fixed electrode 72 for acceleration detection of the sensor element 4 are disposed to have an overlapping region S1 where positions along the Z direction overlap and a non-overlap region S2 where positions along the Z direction do not overlap. The movable electrode for direction detection and the fixed electrode for direction detection may be configured by the movable electrode for acceleration detection and the fixed electrode for acceleration detection of the sensor element 4. Furthermore, the movable electrode for direction detection and the fixed electrode for direction detection may be configured by the movable electrode for acceleration detection and the fixed electrode for acceleration detection of the sensor element 3 and the sensor element 4.

Regarding the acceleration sensor 101 according to this embodiment, when an acceleration along the thickness direction of the substrate 10 acts on the acceleration sensor 101, the first mass portion 20 is displaced relative to the substrate 10 along the thickness direction of the substrate 10, and the second mass portion 40 is displaced in a direction that approaches the first mass portion 20 along a direction perpendicular to the thickness direction of the substrate 10. By arranging the movable electrode 51 and the fixed electrode 52 on the second mass portion 40 and the substrate 10 to face each other along the direction perpendicular to the thickness direction of the substrate 10, the acceleration along the thickness direction of the substrate 10 can be detected by detecting a capacitance between the movable electrode 51 and the fixed electrode 52 that are displaced in the direction perpendicular to the thickness direction of the substrate 10. Compared to a case when the capacitance is detected between a movable electrode and a fixed electrode displaced in a thickness direction of the substrate, the sensitivity of the sensor can be improved.

The acceleration sensor 101 includes a first sensor element 2 for detecting an acceleration along a first direction, which is the thickness direction of the substrate 10, and a second sensor element 3 for detecting an acceleration along a second direction perpendicular to the first direction. The second sensor element 3 includes a movable electrode 61 for acceleration detection disposed on the first mass portion 20 and a fixed electrode 62 for acceleration detection disposed on the substrate 10. The movable electrode 61 for direction detection and the fixed electrode 62 for direction detection are configured by the movable electrode 61 for acceleration detection and the fixed electrode 62 for acceleration detection of the second sensor element 3.

Therefore, the movable electrode 61 for acceleration detection and the fixed electrode 62 for acceleration detection of the second sensor element 3 used for detecting the acceleration along the second direction perpendicular to the thickness direction of the substrate 10 are also usable as the movable electrode 61 for direction detection and the fixed electrode 62 for direction detection that are used to detect the acceleration direction along the first direction, which is the thickness direction of the substrate 10. The acceleration along the direction perpendicular to the thickness direction of the substrate 10 can also be detected using the movable electrode 61 for direction detection and the fixed electrode 62 for direction detection.

The acceleration sensor 101 includes a first sensor element 2 for detecting an acceleration along a first direction, which is the thickness direction of the substrate 10, a second sensor element 3 for detecting an acceleration along a second direction perpendicular to the first direction, and a third sensor element 4 for detecting an acceleration along a third direction perpendicular to the first direction and the second direction. Each of the second sensor element 3 and the third sensor element 4 includes a movable electrode 51 for acceleration detection disposed on the first mass portion 20 and a fixed electrode 52 for acceleration detection disposed on the substrate 10. The movable electrode 61 for direction detection and the fixed electrode 62 for direction detection are configured by the movable electrodes 61, 71 for acceleration detection and the fixed electrodes 62, 72 for acceleration detection of at least one of the second sensor element 3 and the third sensor element 4.

Therefore, the movable electrodes 61, 71 for acceleration detection and the fixed electrodes 62, 72 for acceleration detection of at least one of the second sensor element 3 used for detecting the acceleration along the second direction perpendicular to the thickness direction of the substrate 10 and the third sensor element 4 used for detecting the acceleration along the third direction perpendicular to the thickness direction of the substrate 10 and perpendicular to the second direction are also usable as the movable electrode for direction detection and the fixed electrode for direction detection that are used to detect the acceleration direction along the first direction, which is the thickness direction of the substrate 10. The acceleration along the first direction which is the thickness direction of the substrate 10, the second direction perpendicular to the first direction and the third direction perpendicular to the first direction and the second direction can be detected.

The present disclosure is not limited to the illustrated embodiments, and various improvements and changes in design are possible without departing from the content of the present disclosure.

### [Note 1]

An acceleration sensor, comprising:
a substrate; and
a first mass portion, supported by the substrate so as to be movable along a thickness direction of the substrate; and
a beam portion, supporting the first mass portion on the substrate, wherein
the beam portion includes:
   a second mass portion, having a mass less than a mass of the first mass portion;
   a first spring portion, connecting the first mass portion with the second mass portion; and
   a second spring portion, having a spring constant smaller than a spring constant of the first spring portion and connecting the second mass portion with the substrate, wherein
   a movable electrode of a sensor element is disposed on the second mass portion and configured to detect an acceleration along the thickness direction of the substrate, and
   a fixed electrode of the sensor element is disposed on the substrate.

### [Note 2]

The acceleration sensor of Note 1, wherein
the movable electrode includes a movable electrode portion formed in a comb-teeth shape, and
the fixed electrode includes a fixed electrode portion formed in a comb-teeth shape.

### [Note 3]

The acceleration sensor of Note 2, wherein the movable electrode portion and the fixed electrode portion are arranged to face each other along a direction perpendicular to the thickness direction of the substrate.

### [Note 4]

The acceleration sensor of Note 1, wherein
the substrate has a cavity partially exposed on a surface, and
the first mass portion and the beam portion are provided on the substrate to be disposed within the cavity.

### [Note 5]

The acceleration sensor of Note 1, wherein
the acceleration sensor includes a plurality of the beam portions, and
the plurality of beam portions are evenly arranged around the first mass portion in a plan view.

### [Note 6]

The acceleration sensor of Note 5, wherein
the acceleration sensor includes two of the beam portions, and
The two beam portions are formed symmetrically with the first mass portion in between.

### [Note 7]

The acceleration sensor of Note 5, wherein the acceleration sensor includes four of the beam portions.

### [Note 8]

The acceleration sensor of Note 1, comprising a direction detection mechanism configured to detect an acceleration direction along the thickness direction of the substrate.

### [Note 9]

The acceleration sensor of Note 8, wherein
the movable electrode is a movable electrode for acceleration detection,
the fixed electrode is a fixed electrode for acceleration detection,
the direction detection mechanism includes a movable electrode for direction detection and a fixed electrode for direction detection configured to detect the acceleration direction along the thickness direction of the substrate,
the movable electrode for direction detection is disposed on the first mass portion, and
the fixed electrode for direction detection is disposed on the substrate.

### [Note 10]

The acceleration sensor of Note 9, wherein the movable electrode for direction detection and the fixed electrode for direction detection include:
an overlap region, where positions along the thickness direction of the substrate overlap; and
a non-overlap region, where positions along the thickness direction of the substrate do not overlap.

### [Note 11]

The acceleration sensor of Note 9, comprising:
a first sensor element, configured to detect acceleration along a first direction that is the thickness direction of the substrate; and
a second sensor element, configured to detect acceleration along a second direction perpendicular to the first direction, wherein
the second sensor element includes:
   a movable electrode for acceleration detection, disposed on the first mass portion; and
   a fixed electrode for acceleration detection disposed on the substrate, and wherein
the movable electrode for direction detection and the fixed electrode for direction detection comprise the movable electrode for acceleration detection and the fixed electrode for acceleration detection of the second sensor element.

### [Note 12]

The acceleration sensor of Note 9, comprising:
a first sensor element, configured to detect acceleration along a first direction that is the thickness direction of the substrate;
a second sensor element, configured to detect acceleration along a second direction perpendicular to the first direction; and
a third sensor element, configured to detect acceleration along a third direction perpendicular to the first direction and the second direction, wherein
each of the second sensor element and the third sensor element includes:
   a movable electrode for acceleration detection, disposed on the first mass portion; and
   a fixed electrode for acceleration detection disposed on the substrate, and wherein
the movable electrode for direction detection and the fixed electrode for direction detection comprise the movable electrode for acceleration detection and the fixed electrode for acceleration detection of at least one of the second sensor element and the third sensor element.

1. An acceleration sensor, comprising:
a substrate; and
a first mass portion, supported by the substrate so as to be movable along a thickness direction of the substrate; and
a beam portion, supporting the first mass portion on the substrate, wherein
the beam portion includes:
a second mass portion, having a mass less than a mass of the first mass portion;
a first spring portion, connecting the first mass portion with the second mass portion; and
a second spring portion, having a spring constant smaller than a spring constant of the first spring portion and connecting the second mass portion with the substrate, wherein
a movable electrode of a sensor element is disposed on the second mass portion and configured to detect an acceleration along the thickness direction of the substrate, and
a fixed electrode of the sensor element is disposed on the substrate.

2. The acceleration sensor of claim 1, wherein
the movable electrode includes a movable electrode portion formed in a comb-teeth shape, and
the fixed electrode includes a fixed electrode portion formed in a comb-teeth shape.

3. The acceleration sensor of claim 2, wherein the movable electrode portion and the fixed electrode portion are arranged to face each other along a direction perpendicular to the thickness direction of the substrate.

4. The acceleration sensor of claim 1, wherein
the substrate has a cavity partially exposed on a surface, and
the first mass portion and the beam portion are provided on the substrate to be disposed within the cavity.

5. The acceleration sensor of claim 1, wherein
the acceleration sensor includes a plurality of the beam portions, and
the plurality of beam portions are evenly arranged around the first mass portion in a plan view.

6. The acceleration sensor of claim 5, wherein
the acceleration sensor includes two of the beam portions, and
the two beam portions are formed symmetrically with the first mass portion in between.

7. The acceleration sensor of claim 5, wherein the acceleration sensor includes four of the beam portions.

8. The acceleration sensor of claim 1, comprising a direction detection mechanism configured to detect an acceleration direction along the thickness direction of the substrate.

9. The acceleration sensor of claim 8, wherein
the movable electrode is a movable electrode for acceleration detection,
the fixed electrode is a fixed electrode for acceleration detection,
the direction detection mechanism includes a movable electrode for direction detection and a fixed electrode for direction detection configured to detect the acceleration direction along the thickness direction of the substrate,
the movable electrode for direction detection is disposed on the first mass portion, and
the fixed electrode for direction detection is disposed on the substrate.

10. The acceleration sensor of claim 9, wherein the movable electrode for direction detection and the fixed electrode for direction detection include:
an overlap region, where positions along the thickness direction of the substrate overlap; and
a non-overlap region, where positions along the thickness direction of the substrate do not overlap.

11. The acceleration sensor of claim 9, comprising:
a first sensor element, configured to detect acceleration along a first direction that is the thickness direction of the substrate; and
a second sensor element, configured to detect acceleration along a second direction perpendicular to the first direction, wherein
the second sensor element includes:
a movable electrode for acceleration detection, disposed on the first mass portion; and
a fixed electrode for acceleration detection disposed on the substrate, and wherein
the movable electrode for direction detection and the fixed electrode for direction detection comprise the movable electrode for acceleration detection and the fixed electrode for acceleration detection of the second sensor element.

12. The acceleration sensor of claim 9, comprising:
a first sensor element, configured to detect acceleration along a first direction that is the thickness direction of the substrate;
a second sensor element, configured to detect acceleration along a second direction perpendicular to the first direction; and
a third sensor element, configured to detect acceleration along a third direction perpendicular to the first direction and the second direction, wherein
each of the second sensor element and the third sensor element includes:
a movable electrode for acceleration detection, disposed on the first mass portion; and
a fixed electrode for acceleration detection disposed on the substrate, and wherein
the movable electrode for direction detection and the fixed electrode for direction detection comprise the movable electrode for acceleration detection and the fixed electrode for acceleration detection of at least one of the second sensor element and the third sensor element.
